(19) United States
(12) Patent Application Publication
(10) Pub. No.: US 2014/0328080 A1
(43) Pub. Date: Nov. 6, 2014

(54) ARC LAMP HAVING DUAL PARABOLOID RETROREFLECTOR

(71) Applicant: WAVIEN, INC., Valencia, CA (US)

(72) Inventor: Kenneth LI, Castaic, CA (US)

(73) Assignee: WAVIEN, INC., Valencia, CA (US)

(21) Appl. No.: 14/264,514

(22) Filed: Apr. 29, 2014

Related U.S. Application Data
(60) Provisional application No. 61/817,935, filed on May 1, 2013.

(51) Int. Cl. F21V 7/06; F21V 7/08

(52) U.S. Cl. CPC F21V 7/06; F21V 7/08
USPC 362/551; 362/298

(57) ABSTRACT

An illumination system comprises an arc lamp having a cathode and an anode which emit light from a hot spot. A dual paraboloid retroreflector comprising upper and lower halves intercept light emitted rearwardly from the arc lamp and reflects the intercepted light back towards the hot spot. The retroreflector is spaced from the hot spot at a distance such that light rays emitted from the hot spot which are incident on the upper or lower half are redirected to a corresponding surface of the other half and reflected back to the hot spot. The system may further include a main dual paraboloid reflector for redirecting output light from the arc lamp and retroreflector. Light emitted from the arc lamp is intercepted by a first half paraboloid reflector and collimated to be redirected toward to a corresponding surface of a second half paraboloid reflector member, so as to be reflected in a direction opposite to the arc lamp output. The system may include a pair of ellipsoid reflectors, one of which intercepts the arc lamp output and directs the light onto a corresponding surface of the other ellipsoid reflector, which change the output direction of the light to be parallel to the arc lamp output.

### CROSS-REFERENCE TO RELATED APPLICATIONS

The present application claims priority on U.S. provisional patent application No. 61/817,935 filed on May 1, 2013.

### BACKGROUND OF THE INVENTION

Retroreflectors have been used in lamps for many years in order to increase the intensity of the output. Generally, the retroreflector is positioned behind the light source and reflects light which is incident on the reflector back onto the light source itself. Retroreflectors are used extensively in arc lamps which are used, for example, in search lights and cinema projectors.

FIG. 1 shows an example of a known arc lamp assembly 10 having an arc lamp 11 conventional retroreflector 12. The arc lamp includes a glass envelop 14, a cathode 16, and an anode 18. As shown, there is a gap between the tip 20 of the cathode 16 and the tip 22 of the anode 18 across which an electrical arc spans when the lamp is powered. As shown, the electrode tips 20, 22 are not symmetrical, with the tip 22 of the anode 18 being larger than the cathode tip, which is the case in most arc lamps, especially DC lamps.

In the system 10 shown in FIG. 1, the lamp 11 is designed to emit light in a direction centered about the axis D. The retroreflector 12 has a spherical inner surface 24 which is centered about the axis D and spaced from the lamp 11 at an axial distance such that light from the lamp 11 which is incident upon the surface 24 is reflected back toward the lamp 11 as shown by arrows 26. Thus, according to known systems, light which is emitted by the lamp 11 in an undesired direction is reflected by the retroreflector 12 so that it is emitted in the direction centered around axis D.

Referring to FIG. 2a, in which the lamp envelope 14 has been omitted for clarity, in reality the intensity of the arc between the electrodes 16, 18 is not uniform. Instead, the arc usually forms a hot spot 30 near the tip 20 of the cathode 16. Light emanating from the hot spot 30 which reaches the inner surface 24 of the reflector 12 is not reflected back to the hot spot 30 but rather, a shown, is reflected back to an imaging point 32 close to the tip 22 of the anode 18. This is an imaging property in which the image 32 is inverted relative to the object (the hot spot 30). Thus, the image 32 of the hot spot 30 will be near the anode's tip 22. FIG. 2b illustrates the inverted state of the reflected image.

While the inversion of the image and the object will not affect the recapture of most of the reflected light waves, e.g., ray 31, in the case of light rays 34 emitted toward the upper portion of the reflector 12 (assuming that the anode 18 is positioned as in FIG. 2a), the reflected light rays 35 will impact on the anode tip 22 and be blocked, as shown at 36. The blocked rays 35 will result in a reduction in efficiency in coupling and is not desirable.

### SUMMARY OF THE INVENTION

An illumination system comprises an arc lamp having a cathode and an anode which emit light from a hot spot. A dual paraboloid retroreflector comprising upper and lower halves intercepts light emitted rearwardly from the arc lamp and reflects the intercepted light back towards the hot spot. The retroreflector is spaced from the hot spot at a distance such that light rays emitted from the hot spot which are incident on one retroreflector half are redirected to a corresponding surface of the other retroreflector half and reflected back to the hot spot.

The system may further include a main dual paraboloid reflector for redirecting output light from the arc lamp. Light emitted from the arc lamp is intercepted by a first half paraboloid reflector and collimated to be redirected toward to a corresponding surface of a second half paraboloid reflector member, so as to be reflected in a direction opposite to the output of the arc lamp and retroreflector.

The system may include a pair of ellipsoid reflectors to change the direction of light to be generally in the same direction as the arc lamp output but spaced from original direction.

The system may further include a light pipe located at the focal point of the output of the main or second dual paraboloid reflector for receiving substantially all of the light output.

### BRIEF DESCRIPTION OF THE DRAWINGS

FIG. 1 is side, partially sectional view of a lamp assembly with an arc lamp and a retroreflector according to the prior art;

FIG. 2a is another side, partially sectional view of the lamp assembly of FIG. 1, with the lamp envelope omitted for simplicity;

FIG. 2b is a schematic representation of the imaging property of the lamp assemblies of FIGS. 1 and 2a;

FIG. 3a is a side, partially sectional view of a lamp assembly with an arc lamp and a retroreflector according to the invention;

FIG. 3b is a schematic representation of the imaging property of the lamp assembly of FIG. 3a;

FIG. 4 is a schematic view of an illumination system using the lamp assembly of FIG. 3a; and

FIG. 5 is a schematic view of an alternative illumination system using the lamp assembly of FIG. 3a.

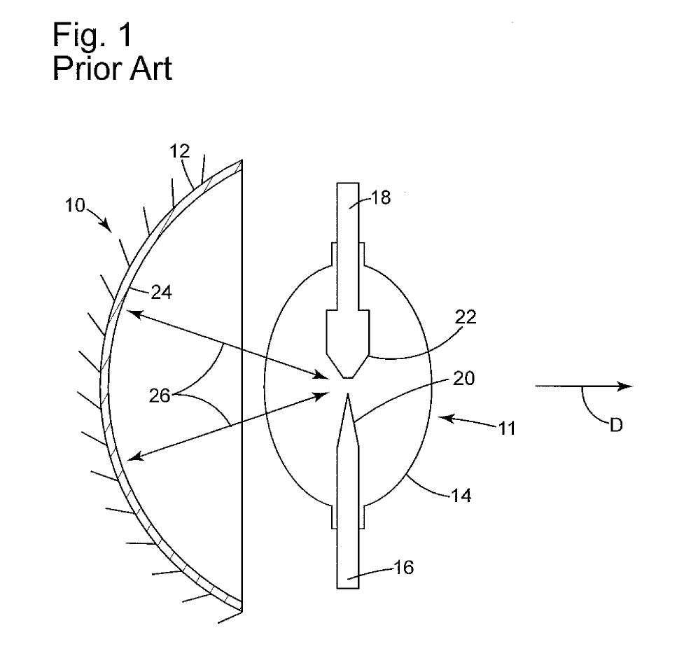

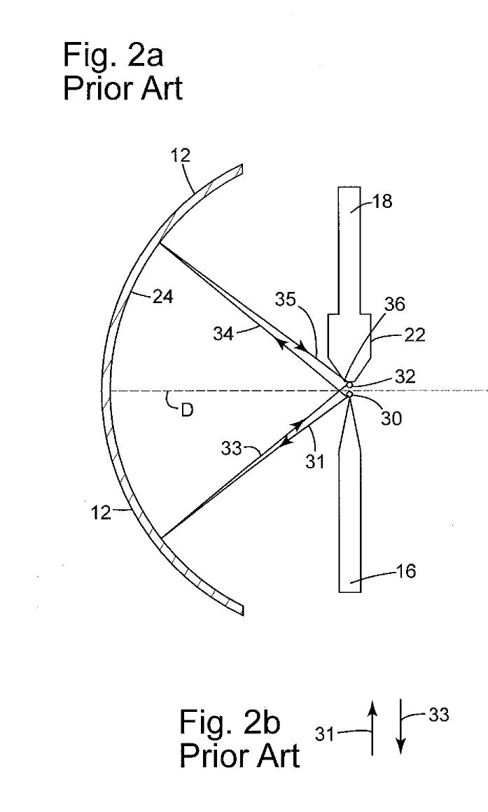

### DETAILED DESCRIPTION OF THE INVENTION

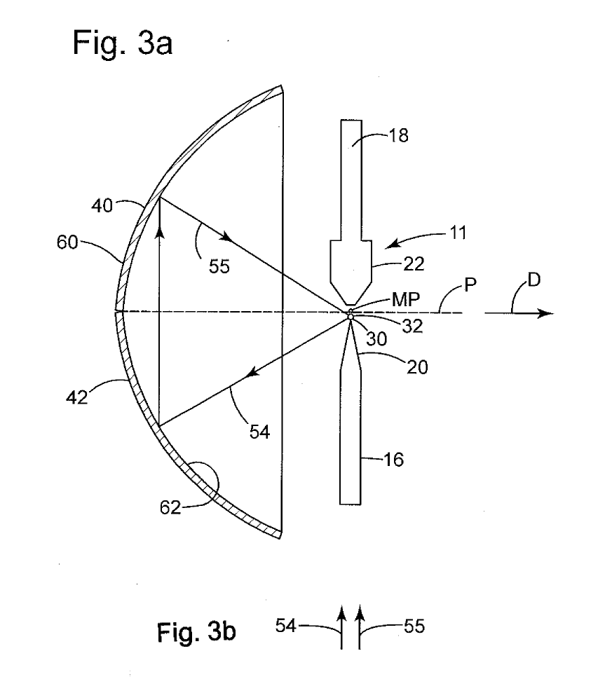

Referring to FIG. 3a, in which the glass envelop 14 has again been omitted for clarity, the present invention includes an arc lamp 11 comprising a cathode 16 and an anode 18. As in the case of prior art lamps, the arc in the gap between the cathode tip 20 and the anode tip 22 forms a hot spot 30 which is close the cathode tip 20.

In place of a spherical reflector 12, the present invention employs an upper parabolic reflector half 40 and a lower parabolic reflector half 42. As shown, the gap 44 between the cathode tip 20 and the anode tip 22 extends in a first, vertical direction. The lower edge 50 of the upper parabolic reflector half and upper edge 52 of the lower parabolic reflector half 42 meet along a plane P which extends through the midpoint MP between the cathode tip 20 and anode tip 22 and is oriented perpendicular to the vertical direction. Axis D also lies in the plane P.

As shown in FIG. 3a, the upper and lower parabolic reflector halves 40, 42 lie at an axial distance from the hot spot 30 such that light rays 54 emitted from the hot spot 30 which strike the inner surface 60, 62 of the upper parabolic reflector half 40 or lower parabolic reflector half 42 are reflected onto the corresponding inner surface 62, 60 of the other parabolic reflector half, where they are in turn reflected back to the hot spot 30. Thus, as shown schematically in FIG. 3b, the object and the image locations are not inverted.

Thus, the property of the dual paraboloid reflector halves 40, 42 is that the image remains upright and is not inverted as in the prior art. The hot spot 30 will be imaged back onto itself, rather than being partially imaged back onto the anode as in the prior art. Thus, no portion of the reflected rays 54 will be blocked by the anode 22.

The inner reflecting surfaces 60, 62 of the upper and lower parabolic reflector halves 40, 42 are substantially mirror images of one another and, as described above, are located at the focal plane perpendicular to the optical axis of the parabolic reflector. Both sections are then put together with the focal point overlapping each other. The arc of the lamp is then positioned at this common focus. Since the light from the arc is at the focus, it will be collimated by the parabolic reflector half 40 or 42 which it first encounters and refocused onto the other parabolic reflector half 42 or 40.

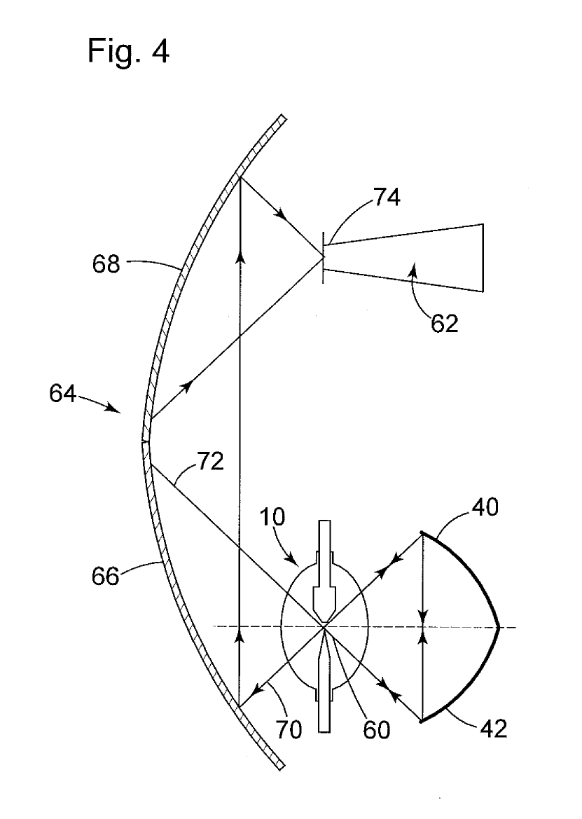

FIG. 4 shows an illumination system using a dual paraboloid reflector pair 40, 42 for coupling light from the arc 60 to the input of a light pipe 62. Light output from the arc lamp 11 is directed to a main paraboloid reflector pair 64 which is formed of a pair of sections. The first section 66 collimates light rays 70, 72 from the arc lamp 11 toward a corresponding surface of the second section 68, which in turn reflects the light rays 70, 72 towards the input 74 of the light pipe 62, which is located at the focal point of the second section 68. Such main reflector systems are known and need not be described further here.

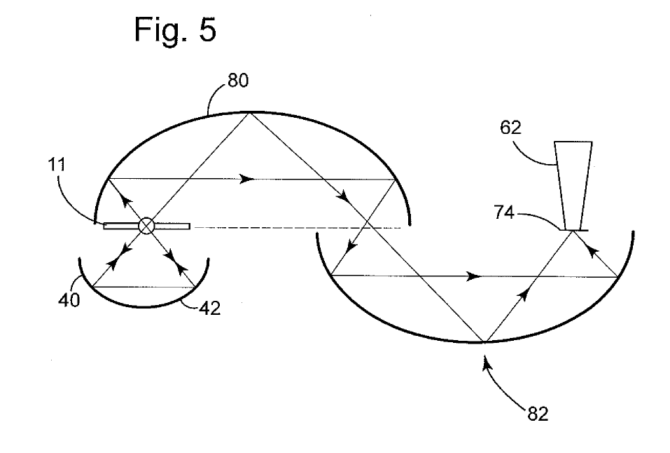

FIG. 5 shows another illumination system employing a pair of ellipsoid reflectors 80, 82, one being upside down compared to the other, for coupling light from the arc lamp 11 to the input 74 of a light pipe 62.

Although the light pipe 62 is shown as a tapered light pipe, other shapes of light pipes, which themselves are well known, may be used.

In the case of the systems shown in FIGS. 4 and 5, the dual paraboloid reflector pair 40, 42 collects the portion of light emitted in the reverse direction and refocuses it back to the arc 60, preferably on the hot spot 30, without inverting the image. The hot spot near the smaller cathode will be focused back onto the hot spot itself without being blocked by the larger anode. The dual paraboloid reflectors improve the efficiency of the system compared to conventional devices.

The foregoing description represents the preferred embodiments of the invention. Various modifications will be apparent to persons skilled in the art. All such modifications and variations are intended to be within the scope of the invention, as set forth in the following claims.

1. An illumination system comprising an arc lamp having a cathode and an anode, each having a tip, wherein said tips are spaced from one another in a first direction;
wherein said arc lamp emits light at a hot spot located between said tips;
a dual paraboloid retroreflector comprising upper and lower halves which are at least essentially mirror images of one another and which together intercept light emitted from said arc lamp on one side of a plane in which said first direction lies, and reflects the intercepted light back towards said hot spot, such that said illumination system emits light in a direction centered about an axis “D;”
wherein said upper half has a lower edge and said lower half has an upper edge which meet in a plane perpendicular to said first direction;
wherein said plane extends between said tips; and
wherein said upper and lower halves are spaced from said hot spot at a distance such that light rays emitted from said hot spot which are incident on said upper or lower half are redirected to a corresponding surface of the other half and reflected back to said hot spot.

2. The illumination system of claim 1, wherein said axis “D” intercepts said plane.

3. The illumination system of claim 2, further comprising a main paraboloid reflector pair for intercepting output light from the arc lamp; wherein a first half paraboloid reflector member is positioned at the focal point of the axis “D” at a distance from said arc lamp such that light emitted from said arc lamp is intercepted by said first half paraboloid reflector and collimated to be redirected toward to a corresponding surface of a second half paraboloid reflector member so as to be reflected in a direction opposite to the output of the arc lamp and retroreflector.

4. The illumination system of claim 3, further comprising a light pipe located at the focal point of the second half paraboloid reflector member for receiving substantially all of light output from the second half paraboloid reflector member.

5. The illumination system of claim 1, further comprising an ellipsoid reflector pair comprising a first ellipsoid reflector half and a second ellipsoid reflector half; wherein said first ellipsoid reflector half intercepts substantially all the output light from the arc lamp and reflects such light onto a corresponding surface of the second ellipsoid reflector half.

6. The illumination system of claim 5, further comprising a light pipe located at the focal point of the second ellipsoid reflector half for receiving substantially all of light output from the second ellipsoid reflector half.
